(19) United States
(12) Patent Application Publication
(10) Pub. No.: US 2026/0023338 A1
(43) Pub. Date: Jan. 22, 2026

(54) ELECTROPHOTOGRAPHIC BELT AND ELECTROPHOTOGRAPHIC IMAGE-FORMING DEVICE

(71) Applicant: CANON KABUSHIKI KAISHA, Tokyo (JP)

(72) Inventors: MASAYUKI ONUMA, Chiba (JP); AKIRA OKANO, Kanagawa (JP); MEGUMI UCHINO, Tokyo (JP); KOJI SATO, Ibaraki (JP)

(21) Appl. No.: 19/345,991

(22) Filed: Sep. 30, 2025

Related U.S. Application Data
(63) Continuation of application No. PCT/JP2024/014634, filed on Apr. 11, 2024.

(30) Foreign Application Priority Data
Apr. 13, 2023 (JP) 2023-065502
Mar. 6, 2024 (JP) 2024-033578

(51) Int. Cl. G03G 15/16; C08K 9/08

(52) U.S. Cl. CPC G03G 15/162; C08K 9/08; C08K 2201/001; C08K 2201/003; C08K 2201/006; C08K 2201/011

(57) ABSTRACT

An electrophotographic belt can suppress a decrease in electric resistance and a decrease in the crack resistance even when being repeatedly used for a long period of time. The electrophotographic belt including at least a base layer, wherein the base layer contains a polyether ether ketone resin, which is a thermoplastic resin, and carbon black, the content of the carbon black is 18 to 30 mass % with respect to the mass of the base layer, the base layer has a moisture content of at least 0.50 mass % as measured from a sample cut out from the base layer, and a crystallization temperature of the base layer during cooling is not higher than 288.0° C. that is measured in differential scanning calorimetry.

### CROSS-REFERENCE TO RELATED APPLICATIONS

This application is a Continuation of International Patent Application No. PCT/JP2024/014634, filed Apr. 11, 2024, which claims the benefit of Japanese Patent Application No. 2023-065502, filed Apr. 13, 2023, and Japanese Patent Application No. 2024-033578, filed Mar. 6, 2024, both of which are hereby incorporated by reference herein in their entirety.

### BACKGROUND

### Field of the Technology

The present disclosure relates to an electrophotographic belt and an electrophotographic image forming apparatus including the same.

### Description of the Related Art

Some types of electrophotographic image forming apparatuses such as a copying machine and a laser beam printer (sometimes referred to as “an electrophotographic apparatus”) use an intermediate transfer belt having an endless shape. An endless-shaped electrophotographic belt used as an intermediate transfer belt may have a single-layer configuration composed of only a base layer, or a two-layer or three-layer laminated configuration. The two-layer configuration includes, for example, a base layer and an elastic layer on the outer peripheral surface of the base layer, and the three-layer configuration includes, for example, a base layer, an elastic layer on the outer peripheral surface of the base layer, and a surface layer on the outer peripheral surface of the elastic layer.

For the base layer of such an electrophotographic belt, it has been proposed to use a polyether ether ketone or polyphenyl sulfide, which is a super engineer plastic having high strength, as a binder for a thermoplastic resin that is inexpensive and easy to regenerate. Polyether ether ketone may be described hereinafter as “PEEK”. Polyphenyl sulfide may be described hereinafter as “PPS”. Since crystalline thermoplastic resins such as PEEK or PPS have a high melting point, a conductive filler such as carbon black is used as a conductivity-imparting agent for bringing the base layer into conduction, as described in Japanese Patent Laid-Open No. 2021-009400.

Japanese Patent Laid-Open No. 2021-009400 discloses an invention aimed at providing a sheet-like member for an image forming apparatus with high roller resistance and high cracking resistance. The sheet-like member for an image forming apparatus contains PEEK and a conductive filler of less than 19 mass %, and has a temperature-lowering crystallization peak temperature Tc of less than 299.0° C. Paragraph of Japanese Patent Laid-Open No. 2021-009400 describes that a low Tc leads to low heat resistance but increases the amount of high-molecular weight components, which is advantageous to cracking resistance, and at a higher Tc, low-molecular weight components are crystal nuclei that tend to have a higher degree of crystallinity with high heat resistance and low cracking resistance.

Furthermore, Japanese Patent Laid-Open No. 2021-009400 indicates that PEEK having a low Tc, that is, PEEK having high cracking resistance is selected and is gradually cooled during the film formation process to perform post-crystallization, achieving both of cracking resistance and roller resistance by improving the roller resistance. In addition, paragraph of Japanese Patent Laid-Open No. 2021-009400 indicates that, when the content of the conductive filler in the sheet-like member for the image forming apparatus according to the invention described in Japanese Patent Laid-Open No. 2021-009400 exceeds 19 wt %, the cracking resistance decreases undesirably. From the viewpoint of stably exhibiting conductivity, using a maximum amount of carbon black is preferable. However, the content of carbon black is assumed to be less than 19 mass % in the sheet-like member for the image forming apparatus according to Japanese Patent Laid-Open No. 2021-009400. In an example, the maximum content ratio of carbon black is 16 mass % with respect to the mass of the sheet-like member of carbon black.

In contrast, Japanese Patent Laid-Open No. 2012-177811 discloses that when an electrophotographic belt exhibiting conductivity using a conductive filler is used as, for example, an intermediate transfer belt to form an electrophotographic image over a long period of time, the electrical resistance of the electrophotographic belt may be reduced. Japanese Patent Laid-Open No. 2012-177811 indicates that such a reduction in electrical resistance is caused by the following mechanism.

Discharge occurs at a portion where the intermediate transfer belt separates from a primary transfer roller and a secondary transfer roller, and an excessive current flows into the intermediate transfer belt at one time. At this time, a high voltage is applied between carbon blacks serving as conductive points, and the binder resin interposed between carbon black particles is heated and carbonized. As a result, the carbon black particles, which have been originally electrically insulating, are made conductive, resulting in higher conductivity. Japanese Patent Laid-Open No. 2012-177811 discloses that the reduction in electrical resistance can be solved by improving the dispersibility in the binder resin of carbon black, hence indicates that carbon black and PEEK are repeatedly melted and kneaded (two to six times) for this purpose.

The repetition of the melting and kneading of the binder resin and carbon black as disclosed in Japanese Patent Laid-Open No. 2012-177811 may cause an increase in the manufacturing cost of the electrophotographic belt. Furthermore, the repetition of kneading at high temperatures may cause thermal degradation (cross-linking by thermal decomposition or oxidation) of the binder resin, leading to lower strength of the electrophotographic belt. In addition, even if the dispersibility of the carbon black is highly improved, it is difficult to equalize the inter-particle distances of all carbon blacks. Therefore, when an excessive current flows through the intermediate transfer belt, a high voltage is applied between carbon black particles that are relatively close to each other. This makes it difficult to completely prevent carbonization of the binder resin interposed between the carbon black particles.

### SUMMARY

Accordingly, at least one aspect of the present disclosure is aimed at providing an electrophotographic belt that can achieve, at a higher level, suppression of increase in the conductivity of an electrophotographic belt over time and prevention of cracking during long-term use. In addition, at least one aspect of the present disclosure is aimed at providing an electrophotographic image forming apparatus that can stably form an electrophotographic image of high quality for a long period of time.

According to at least one aspect of the present disclosure, provided is an electrophotographic belt including at least a base layer, wherein
the base layer contains polyether ether ketone, which is a thermoplastic resin, and carbon black,
the content of the carbon black is 18 to 30 mass % with respect to the mass of the base layer, and
the base layer has a moisture content of at least 0.50 mass %, which is calculated by

$$the moisture content of the base layer = ( ( X 2 - X 1 ) / X 2 ) \times 100 ,$$

where X1 is the mass of a sample when the sample cut from the base layer rises in temperature from 30° C. to 100° C. with a rate of 20° C. per minute under a nitrogen atmosphere and is kept at 100° C. for 30 minutes, and X2 is the mass of the sample when the sample is cooled from 100° C. to 30° C. with a rate of 20° C. per minute and is kept in an environment at a temperature of 23° C. and a relative humidity of 50% for 48 hours in the atmosphere, and
the temperature-lowering crystallization temperature of the base layer is not higher than 288.0° C. that is measured in differential scanning calorimetry.

In addition, according to at least one aspect of the disclosure, an electrophotographic image forming apparatus including the electrophotographic belt is provided.

Features of the present disclosure will become apparent from the following description of embodiments with reference to the attached drawings.

### BRIEF DESCRIPTION OF THE DRAWINGS

FIG. 1 is a schematic diagram showing a cross section of an image forming apparatus used for evaluating an image; and

FIGS. 2A and 2B are explanatory drawings showing a configuration example of an electrophotographic belt.

### DESCRIPTION OF THE EMBODIMENTS

In the present disclosure, the description of “from XX to YY” and “XX to YY” representing a numerical range means a numerical range including the lower limit and the upper limit which are endpoints, unless specified otherwise. When the numerical ranges are described in stages, the upper limits and lower limits of the respective numerical ranges can be combined arbitrarily. Furthermore, in the present disclosure, “Ω/□” means “Ω/square”.

An electrophotographic belt according to the present disclosure will be described below.

FIG. 2A is a perspective view of an electrophotographic belt 200 according to one aspect of the present disclosure. The electrophotographic belt may have an endless shape. Examples of the layer configuration include a single-layer (monolayer) structure composed only of a base layer 201 as shown in FIG. 2B taken along line A-A of FIG. 2A. In this case, an outer surface 200-1 of the base layer serves as a toner carrying surface (outer surface) of the electrophotographic belt. The electrophotographic belt 200 includes at least the base layer. As described above, the electrophotographic belt 200 may have an elastic layer on the outer peripheral surface of the base layer 201, or may also have a surface layer on the outer peripheral surface of the elastic layer. Furthermore, a back layer may be provided to cover the inner peripheral surface of the base layer 201.

The base layer contains polyether ether ketone (hereinafter may be referred to as “PEEK”), which is a thermoplastic resin, and carbon black. PEEK may be a binder resin of the base layer. Also, carbon black may be a conductivity-imparting agent. The content of carbon black is 18 to 30 mass % with respect to the mass of the base layer.

X1 is the mass of a sample when the sample cut from the base layer rose in temperature from 30° C. to 100° C. with a rate of 20° C. per minute under a nitrogen atmosphere and was kept at 100° C. for 30 minutes. X2 is the mass of the sample when the sample was then cooled from 100° C. to 30° C. with a rate of 20° C. per minute and was kept in an environment at a temperature of 23° C. and a relative humidity of 50% for 48 hours in the atmosphere.

A value (moisture content) calculated by the moisture content of the base layer=((X2−X1)/X2)×100 is 0.50 mass % or more.

In this equation, X1 is the mass of the sample when the sample cut from the base layer rose in temperature from 30° C. to 100° C. with a rate of 20° C. per minute under the nitrogen atmosphere and was kept at 100° C. for 30 minutes. X1 is assumed to be a mass in a state in which water in the sample is removed (hereinafter also referred to as “dry state”).

Also, X2 is the mass of the sample when the sample in the dry state is cooled from 100° C. to 30° C. with a rate of 20° C. per minute and was kept in an environment at a temperature of 23° C. and a relative humidity of 50% for 48 hours in the atmosphere. X2 is assumed to be a mass in a state in which the sample temporarily placed in the dry state has absorbed water (hereinafter also referred to as “water-absorbing state”).

Thus, the value calculated by ((X2−X1)/X2)×100 is referred to as “moisture content of the base layer” in the present disclosure. The inventors have found that the conductivity of the electrophotographic belt including the base layer having a moisture content of 0.50 mass % or more is less likely to be changed by repeated use over a long period of time.

As described above, it is believed that in the conventional electrophotographic belt including the base layer containing PEEK as a binder resin and carbon black dispersed as conductive particles in the binder resin, the conductivity is increased over time by applying a high voltage between carbon blacks to carbonize the binder resin interposed between the carbon black particles.

In contrast, the base layer according to the present disclosure, which has a moisture content of 0.50 mass % or more as measured by the above method, stably contains a fixed amount of moisture in a normal office environment at a temperature of 23° C. and a relative humidity of 50% in the atmosphere. Even if a high voltage is applied between carbon black particles due to the above discharge phenomenon, the energy of the base layer containing moisture stably is consumed for evaporation and electrolysis of moisture. It is therefore believed that the carbonization of the binder resin present between the carbon black particles is suppressed and the insulation between the carbon black particles is more properly maintained. Consequently, it is believed that the conductivity of the base layer is less likely to be changed (increased) even after repeated use over a long period of time.

As described above, the base layer temporarily placed in a dry state can contain a fixed amount of moisture again after being set in an environment at a temperature of 23° C. and a relative humidity of 50% for 48 hours in the atmosphere. Accordingly, in the electrophotographic belt according to the present disclosure, even if moisture in the base layer is evaporated or decomposed by the application of a high voltage and is temporarily consumed, the base layer can absorb moisture again. Thus, even in long-term use, the carbonization of PEEK can be continuously suppressed. Consequently, it is believed that a change of conductivity can be suppressed even in long-term use.

The glass transition point of the PEEK included in the base layer is, for example, about 143° C. Since the heat-absorbing effect due to moisture becomes apparent at a temperature sufficiently lower than the glass transition point of the PEEK, the effect of suppressing a change in electrical resistance can be expected. The change in electrical resistance is caused by the influence of resin shrinkage or the like due to heat generation.

X1 and X2 are measured using a thermogravimetric measuring device on the following conditions: A plurality of samples cut out with dimensions of 4 mm×4 mm from the electrophotographic belt are loaded on a platinum sample pan having a capacity of 50 μL or 100 μL such that the total mass of the samples is 15 mg±4 mg.

In addition, X1 is the mass of the sample when the sample rose in temperature from 30° C. to 100° C. with a rate of 20° C. per minute under a nitrogen atmosphere and was kept at 100° C. for 30 minutes. X2 is the mass of the sample when the sample was then cooled from 100° C. to 30° C. with a rate of 20° C. per minute and was kept in an environment at a temperature of 23° C. and a relative humidity of 50% for 48 hours in the atmosphere.

A mass change rate calculated by the moisture content of the base layer=((X2−X1)/X2)×100 is defined as the moisture content of the base layer. In the electrophotographic belt according to the present disclosure, the water content of the base layer is 0.50 mass % or more. Note that the water content is less than 0.04% when a similar evaluation is made with a PEEK alone, without any carbon black contained.

The moisture content of the base layer is preferably 0.70 to 1.00 mass %, and more preferably 0.70 to 0.90 mass %. Withing this range, the effect of suppressing the change over time in the conductivity of the base layer is more likely to be exhibited.

Methods of obtaining the base layer with the moisture content in the above range include, for example, a method of using carbon black that is susceptible to moisture adsorption as a conductive filler in the base layer. From the viewpoint of achieving the desired moisture content and the viewpoint of achieving the desired electric resistivity, as described above, the content of carbon black is 18 to 30 mass % with respect to the mass of the base layer.

Thus, the base layer contains 18 mass % or more of carbon black with respect to the mass of the base layer, thereby easily providing the base layer with desired conductivity. However, an increase in the content of carbon black in the base layer may cause cracking in the base layer. As a result of further examination by the inventors, it has been found that even when the content of carbon black in the base layer is 18 to 30 mass % as described above, the cracking resistance can be improved by controlling the temperature-lowering crystallization temperature of the base layer in a specific range.

Specifically, the temperature-lowering crystallization temperature of the base layer needs to measure 288.0° C. or less in differential scanning calorimetry (DSC). The peak temperature detected during the process of lowering the temperature from a molten state in DSC is the temperature-lowering crystallization temperature. The temperature-lowering crystallization temperature is a peak temperature appearing when the sample is cut out from the base layer to be set in the DSC, is raised in temperature to 400° C. by 10° C./min, and then is reduced in temperature to room temperature (25° C.) by 10° C./min.

When the temperature-lowering crystallization temperature is 288.0° C. or lower, the cracking resistance decreases. The inventors have examined the reason why as follows: 288.0° C., the temperature-lowering crystallization temperature is a temperature lower than the temperature-lowering crystallization temperature (292.8° C.) of the PEEK in example 5 of Japanese Patent Laid-Open No. 2012-177811. The base layer containing the PEEK and the carbon black is molded by, for example, extrusion molding a melt of a resin composition for forming the base layer containing the PEEK. At this time, the PEEK is cooled and solidified from the molten state, but during the process, the carbon black serves as a nucleus to promote crystallization. Delaying the crystallization at this time, that is, lowering the temperature-lowering crystallization temperature of the base layer can reduce the degree of crystallinity of the PEEK in the base layer and allow the presence of many amorphous portions. Consequently, it is believed that the cracking resistance is improved.

The temperature-lowering crystallization temperature is preferably 280.0 to 288.0° C., and more preferably 285.0 to 287.8° C. Means for lowering the temperature-lowering crystallization temperature to 288.0° C. or lower is not particularly limited but include the use of furnace black subjected to a surface treatment, which will be described later.

Thus, carbon black preferably contains furnace black. Furnace black is less likely to interact with molecules of the PEEK and relatively less likely to become a crystal nucleus of the PEEK as compared with acetylene black and the like that has been graphitized. Furthermore, the furnace black, which has been subjected to the treatment described later (at least one of surface treatment and nitrogen treatment), is less likely to become the crystal nucleus of the PEEK and can lower the temperature-lowering crystallization temperature of the base layer. The reason why the surface-treated carbon black is less likely to become a crystal nucleus is that fine unevenness is formed on the surface of the surface-treated carbon black and the carbon black has a large surface area.

The method for manufacturing the electrophotographic belt will be specifically described below.

### Binder Resin

The electrophotographic belt is required to be so strong that the belt does not extend even when continuously receiving a tension load over a long period of time in the electrophotographic image forming apparatus. Therefore, thermoplastic resin as a binder resin in the base layer is preferably classified as a super engineering plastic. The base layer according to the present disclosure contains PEEK as a binder resin.

Although PEEK is provided as commercial products of various grades, in the present disclosure, a single grade may be used or two or more grades may be used in combination.

Commercial products of PEEK include the trade name “Victrex PEEK” series from Victrex plc. Moreover, the grades include PEEK grades “450G”, “381G”, and “151G”.

### Carbon Black

The base layer contains carbon black. The carbon black may be a conductivity-imparting agent. The carbon black is preferably, for example, commercially available carbon black subjected to a treatment, which will be described later, to form fine protruded portions of an organic compound on the surface of the carbon black. That is, the carbon black preferably has protruded portions of an organic compound on the surface.

In the present specification, the carbon black before treatment may be referred to as “raw carbon black”. Also, after the treatment, carbon black having fine protruded portions on the surface may be referred to as “treated carbon black” or simply “carbon black”.

The melting point of the PEEK used as the binder resin is, for example, about 330° C. Therefore, when a conductive base layer having an endless shape is manufactured using these resins, it is difficult to use an ionic conductivity-imparting agent, and thus carbon black is used. In order to achieve the above-described surface resistivity using carbon black, the content of carbon black in the base layer is set to 18 to 30 mass % with respect to the mass of the base layer. The content of the carbon black is preferably 19 to 30 mass %, more preferably 19 to 25 mass %, and still more preferably 20 to 24 mass %. The content of PEEK in the base layer is preferably 70 to 81 mass %, more preferably 75 to 81 mass %, and still more preferably 76 to 80 mass %.

At this time, the carbon black preferably has a moisture absorption rate (hereinafter also referred to as CB moisture absorption rate) of 0.70 mass % or more, which is determined by the following formula (1). By using such carbon black, the base layer can easily have a moisture content of 0.50 mass % or more.

The carbon black is placed for 48 hours on conditions that the temperature is 23° C. and the relative humidity is 50%, and then the mass of the carbon black is measured to be W0 using a thermogravimetric analyzer (TGA). The carbon black measuring W0 is raised in temperature from 30° C. to 120° C. with a rate of 20° C. per minute under a nitrogen atmosphere, and is kept at 120° C. for 15 minutes. At this time, the mass of the carbon black is measured to be W1 using the thermogravimetric analyzer (TGA).

$$CB moisture absorption rate = [ ( W 0 - W 1 ) / W 0 ] \times 100 \qquad ( 1 )$$

The CB moisture absorption rate is more preferably 1.00 to 2.00 mass %, and still more preferably 1.10 to 1.50 mass %. The CB moisture absorption rate can be controlled by, for example, increasing the moisture content per unit mass by extending the specific surface area of carbon black to be used.

Furthermore, as described above, the carbon black is preferably furnace black from the viewpoint of suppression of crystallization during molding, and the crystallization temperature can be lowered by increasing the BET specific surface area according to a treatment method, which will be described later.

### Surface Treatment Method for Carbon Black

A surface treatment method for forming fine protruded portions on the surface of raw carbon black to obtain treated carbon black will be described below. Treatment for forming fine protruded portions on the surface of the raw material carbon black includes a first step of attaching an organic substance to the surface of the raw carbon black and a second step of firing the attached organic substance.

The formation of such fine protruded portions makes it easy to increase the BET specific surface area.

First, the first step of attaching the organic substance to the surface of the raw carbon black will be described below.

In the step of attaching the organic substance to the surface of the raw carbon black, the raw carbon black in a solid powder state may be mixed with the organic substance. From the viewpoint of uniformly attaching the organic substance to the surface, the raw carbon black is preferably mixed with the organic substance in liquid. Hereinafter, the process of attaching the organic substance to the surface of the raw carbon black in the liquid will be described.

The first step is the step of dissolving an organic substance in a solvent to obtain an organic substance-dissolved solution, and then adding raw carbon black to the organic substance-dissolved solution and stirring the solution to prepare a raw carbon black dispersion.

Although water or an organic solvent is used as a usable solvent, water is preferable in view of ease of handling and environmental load. An ordinary dispersing agent may be used to obtain a preferred state of dispersion of the raw carbon black.

The organic substance to be attached to the raw carbon black preferably has high affinity for the surface of the raw carbon black and the solvent. Specifically, organic compounds called a cationic surfactant, an anionic surfactant, and a nonionic surfactant are preferable. Among these surfactants, a nonionic surfactant is preferable, which is likely to suppress coarsening due to aggregation also when the carbon black with the attached organic substance is removed in the subsequent step.

The nonionic surfactant is, for example, an ester type or an ether type. The ester type is, for example, glycerin or sorbitan, that is a polyhydric alcohol, or glycerin fatty acid ester, sorbitan fatty acid ester, or sucrose fatty acid ester, that has a structure in which sucrose is ester-bonded to fatty acid. The ether type is, for example, polyoxyethylene alkyl ether, polyoxyethylene alkyl allyl ether, or polyoxyethylene propylene glycol, that is mainly obtained by addition polymerization of ethylene oxide with higher alcohols, alkylphenols, or propylene glycol. Among these compounds, polyoxyethylene alkyl ether that has affinity for solvents as well as for conductive carbon surfaces is suitable.

One type of dispersing agent may be used, or a plurality of dispersing agents may be used in combination.

It is preferable that the ratio of the amount of the organic substance to be added to the solvent and dissolved therein is equal to or smaller than the saturation solubility relative to 100 parts by mass of the solvent and the mass ratio “A/B” is adjusted from 0.1 to 20.0 relative to 100 parts by mass of the solvent, where A is the parts by mass of raw carbon black and B is the parts by mass of the organic substance. A/B is more preferably from 0.5 to 3.0.

By setting the amount of the organic substance to be added at the saturation solubility or less, precipitation of the organic substance is suppressed, facilitating the treatment of the raw carbon black.

Furthermore, by setting the mass ratio A/B of the carbon black to the organic substance at 0.1 or larger, the amount of the organic matter is made appropriate relative to the carbon black, thereby suppressing the amount of the organic substance suspended without being attached to the surface of the raw carbon black. In addition, by setting the mass ratio A/B at 20 or less, the raw carbon black can be treated more efficiently.

In the dissolution of the organic substance in the solvent, means for promoting the dissolution of the organic substance can be selected as appropriate from stirring with a stirring blade, or a combination of means such as ultrasonic vibrations, a homogenizer, and heat treatment. In addition, since foaming may occur during stirring, an antifoaming agent or the like can be suitably selected.

The amount of the raw carbon black to be added to the organic substance-dissolved solution is preferably from 1 to 50 parts by mass and is more preferably from 5 to 30 parts by mass with respect to 100 parts by mass of the solvent.

The raw carbon black is preferably added to the organic substance-dissolved solution little by little. The raw carbon black in the organic substance-dissolved solution may be dispersed by, for example, means such as screw stirring, shear flow (homogenizer, nanomizer), high pressure liquid collision, or medium dispersion (ball mill, bead mill).

Subsequently, the second step of firing the organic substance attached to the surface of the raw carbon black will be described below.

The second step is a step of removing the solvent from the raw carbon black dispersion that is obtained in the first step and contains the organic substance attached to the surface of the raw carbon black, and then firing the obtained solid content.

Known methods can be used to remove the solvent from the raw carbon black dispersion and extract the solid content. For example, heat drying, vacuum drying, centrifugation, and reduced-pressure filtration or the like are usable. In view of a throughput at one time, heat drying is preferred. Examples of heat drying include static drying for a dispersion standing under a heated atmosphere, stirring drying, flush drying for exposing the raw carbon black dispersion to a heated air flow to promote drying, and spray drying for spraying the raw carbon black dispersion in a misted state under a heated atmosphere to promote drying. Spray drying is desirable in view of the throughput and solvent removal efficiency.

Known methods can be used for firing the extracted solid content. A direct heating method and an indirect heating method are available for a firing apparatus. In a method of directly heating an object with a flame of a burner or the like, temperature control is difficult and the object may be burnt down. Thus, the indirect heating method is preferred. Specifically, an electric furnace, a circulating hot air oven, and a high-frequency induction heating furnace or the like are available. A circulating hot air oven having a highly uniform heating temperature is preferred. Furthermore, the heating furnace is a batch-type heating furnace or a continuous-type heating furnace. The batch-type heating furnace is preferred because the continuous-type heating furnace has a mechanism of charge and discharge but is not suitable for long-time heating. In order to suppress excessive firing, the atmosphere in the heating furnace may be replaced with, for example, nitrogen.

The firing temperature is preferably not lower than the thermal decomposition starting temperature of the organic substance and less than the decomposition temperature of the raw carbon black. By setting the firing temperature to be equal to or higher than the thermal decomposition starting temperature of the organic substance, the organic substance attached to the surface of the raw carbon black is decomposed, facilitating the formation of the treated carbon black having a protruded portion on the surface. Furthermore, by setting the firing temperature to be less than the decomposition temperature of the raw carbon black, the burning of the raw carbon black during the treatment process can be suppressed. Specifically, the firing temperature is preferably set from, for example, from 300° C. to 600° C. and is particularly preferable at from 350° C. to 500° C.

The obtained carbon black (treated carbon black) preferably has a BET specific surface area of 240 m²/g or more. Moreover, the BET specific surface area of the carbon black is preferably 240 to 300 m²/g, more preferably 250 to 300 m²/g, and still more preferably 250 to 270 m²/g. In the above ranges, the temperature-lowering crystallization temperature can be controlled more easily by the above ranges.

The BET specific surface area can be determined from the amount of nitrogen adsorbed on the particle surface of the carbon black when the degassed carbon black is immersed in liquid nitrogen and is brought into equilibrium (Japan Industrial Standard (JIS) K6217-2:2017).

Moreover, the DBP (dibutyl phthalate) absorption of the carbon black is preferably 100 to 200 mL/100 g and more preferably 130 to 160 mL/100 g.

### CB Moisture Absorption Rate

As described above, it is believed that the carbonization of the binder resin is mainly caused by the application of a high voltage between carbon black particles. For this reason, the moisture content of the base layer is preferably set at 0.50 mass % or more by using carbon black having a large moisture adsorption. In this case, the base layer containing the PEEK as binder resin needs to be subjected to kneading at about 300 to 400° C. during the manufacturing process. Therefore, it is preferable that the carbon black contained in the base layer can maintain the moisture adsorption capacity of a certain amount even after being subjected to the temperature of this level. Specifically, the treated carbon black is preferably carbon black that satisfies the CB moisture absorption rate.

Adsorption of water to carbon black is due to functional groups present on the surface of the carbon black and due to a structure of carbon black. In this case, the functional groups on the surface of carbon black are considered to disappear in the process of kneading the carbon black at a temperature equal to or higher than the melting point of the PEEK. Thus, the ability to adsorb water by such functional groups is lost after the kneading of the PEEK. In contrast, the structure of the carbon black is hardly lost through the kneading process of the PEEK. Thus, the adsorption of water by the structure is reversible.

This is because, in the presence of carbon black with a developed structure in the base layer, even if a high voltage is applied between the particles of the carbon black and water adsorbed by the carbon black is lost by evaporation or electrolysis, moisture in the surrounding environment is absorbed into the structure of the carbon black. Consequently, it is believed that the base layer can stably contain a fixed amount of water.

### CB Moisture Content

Here, regardless of the presence or absence of the foregoing surface treatment, the amount of water contained in the carbon black (hereinafter also referred to as “CB moisture content”) can be measured and calculated by the following steps (iv) and (v).

Step (iv): the mass (W2) of the carbon black to be determined is measured using a TGA after being placed for 48 hours on conditions that the temperature is 23° C. and the relative humidity is 50%.

Step (v): the mass (W3) of the carbon black is measured using the TGA after the carbon black measuring the mass (W2) is raised in temperature from 30° C. to 120° C. with a rate of 20° C. per minute under a nitrogen atmosphere and is kept at 120° C. for 15 minutes.

The CB moisture content (mass %) is calculated by the following formula (2):

$$CB moisture content = ( ( W 2 - W 3 ) / W 2 ) \times 100 \qquad ( 2 )$$

The CB moisture content is preferably 1.00 to 4.00 mass %, more preferably 2.00 to 3.00 mass %, and still more preferably 2.50 to 2.80 mass %.

For commercially available carbon black “#3230B” and “PrintexL” listed below, the CB moisture content (%) determined by the formula (2) and the CB moisture absorption rate determined by the formula (1) are shown in Table 1 below.
“#3230B” (trade name, manufactured by Mitsubishi Chemical Corporation)
“PrintexL” (trade name, manufactured by Orion Engineered Carbons S.A.)

TABLE 1

| | CB moisture | CB moisture |
|---|---|---|
| | content | absorption rate |
| Carbon black type | (%) | (%) |
| “#3230B” | 2.36 | 0.98 |
| “PrintexL” | 1.29 | 0.37 |

“PrintexL” has a relatively high CB water content, but the CB water absorption rate is quite low. Hence, it can be presumed that the moisture content of “PrintexL” forms a large proportion that affects the functional groups on the surface of the carbon black. In contrast, as compared to “PrintexL”, “#3230B” has adsorbed a large amount of moisture even after high-temperature firing. It is thus presumed that “#3230B” has a developed structure and is capable of reversibly adsorbing moisture.

Accordingly, “#3230B” can be suitably used as carbon black to be contained in the base layer. In addition to “#3230B”, as commercially available carbon black having a CB moisture absorption rate of 0.70 mass % or more, for example, “#44B” (trade name, manufactured by Mitsubishi Chemical Corporation; moisture absorption rate=0.95%) can be used. Carbon blacks usable to obtain the base layer are not limited thereto.

The CB moisture absorption rate can also be measured and calculated using carbon black extracted from the base layer, according to the above-described steps. Specifically, for example, if the binder resin is PEEK, a sample collected from the base layer is heated at a temperature of 600° C. for one hour in an atmosphere of nitrogen gas, so that the PEEK in the sample is decomposed and the carbon black in the base layer can be extracted.

By using the carbon black extracted thus, the content of the carbon black in the base layer can also be calculated.

The number-average particle diameter of the primary particle of the carbon black is preferably equal to or greater than 15 nm and less than 35 nm, and is more preferably 20 to 30 nm. With the foregoing range, the carbon black can be more reliably prevented from being altered by heat applied in the manufacturing process of the base layer. Furthermore, the carbon black can be uniformly dispersed in the PEEK with greater ease.

### Method for Manufacturing Electrophotographic Belt

The electrophotographic belt can be manufactured by a method including the following steps:
melting and kneading PEEK, a thermoplastic resin, and carbon black to prepare a pellet-shaped conductive resin composition; and
melting the pellet-shaped conductive resin composition using a single-screw extruder, extruding the melt from a cylindrical slit disposed at the distal end of the extruder, cooling the extruded resin composition by a cylindrical cooling mandrel, and cutting the resin composition at a predetermined length.

The steps of melting and kneading the conductive filler and the thermoplastic resin to prepare a pellet-shaped conductive resin composition will be described below.

The melting and kneading of the conductive filler and the thermoplastic resin can be performed by known methods. For example, a single-screw extruder, a twin-screw kneading extruder, a Banbury mixer, a roll, a Brabender, a plastograph, and a kneader can be used. Of these, a single-screw extruder and a double-screw kneading extruder are preferred from the viewpoint that a material can be continuously supplied to be melted and kneaded and that the melted and kneaded resin composition is molded into a pellet shape. In order to improve the dispersion of the carbon black into the thermoplastic resin and in order to impart specific functions, necessary addition agents may be formulated. When the carbon black contains a large amount of moisture, the carbon black is preferably kneaded while reduced-pressure degassing is performed during heating.

The temperature at the time of melting and kneading with the thermoplastic resin is not lower than the glass transition temperature of the thermoplastic resin and in a temperature range where the thermoplastic resin is not decomposed. For example, when the PEEK is used, the melting and mixing temperature is preferably from 250° C. to 400° C., and more preferably from 300° C. to 400° C. When the melting and kneading temperature is equal to or higher than the glass transition temperature, the viscosity of the resin decreases and shearing is not largely performed in the melting and kneading, so that the molecular structure of the resin is hardly cut. Furthermore, when the melting and kneading temperature is 400° C. or less, oxidation and crosslinking of the resin are hardly promoted, and a strong structure is less likely to be formed.

The process of molding the pellet-shaped conductive resin composition as an electrophotographic belt will be described below.

The resulting pellet-shaped conductive resin composition is melted in a single-screw extruder and is extruded into a tubular shape from a cylindrical slit disposed at the distal end of the extruder. While the temperature of the resin composition extruded into the tubular shape is controlled by a cylindrical cooling mandrel, the resin composition is cut to a predetermined length to obtain the base layer of the electrophotographic belt. The temperature during the extrusion more preferably ranges from the melting point of resin to 400° C.

The conductivity of the base layer is not particularly limited, but in view of primary transferability and secondary transferability when the resin composition is used as an intermediate transfer belt, the base layer preferably has a surface resistivity of, for example, from 1.0×10³Ω/□ to 1.0×10¹⁴Ω/□. More preferably, the surface resistivity is from 1.0×10⁵Ω/□ to 1.0×10¹³Ω/□, and still more preferably, the surface resistivity is from 1.0×10⁹Ω/□ to 1.0×10¹³Ω/□.

The base layer preferably has a thickness of, for example, 25 to 100 μm, and more preferably has a thickness of 40 to 80 μm.

The resulting base layer may further be subjected to heating and cooling treatment. The PEEK varies significantly in mechanical strength depending on the degree of crystallinity. Therefore, the degree of crystallinity can be adjusted by performing heating and cooling treatment according to the situation of use, and the electrophotographic belt having desired mechanical strength can be obtained.

Furthermore, the base layer obtained through the above steps has been subjected to the heating step, so that the moisture content may be temporarily low immediately after manufacturing. However, during storage for 48 hours or more in an environment at a temperature of 23° C. and a relative humidity of 50%, the moisture content of the base layer can be controlled in the above-mentioned range.

The base layer obtained thus may be subsequently provided with a surface layer covering the outer peripheral surface and a back layer covering the inner peripheral surface as necessary. Examples of the surface layer include a highly wear-resistant layer including, for example, a cured product of an active energy ray-curable resin such as an acrylic resin. In this case, the surface layer can be provided by applying a composition containing an active energy ray-curable resin such as a photo-curable resin onto the outer peripheral surface of the base layer, and hardening the composition. The thickness of the surface layer is not particularly limited and is preferably, for example, 1 to 5 μm. Examples of the back layer include, for example, a resin layer for reinforcing the base layer and a conductive layer for bringing the inner peripheral surface of the electrophotographic belt into conduction. The thickness of the back layer is not particularly limited, and is preferably, for example, 0.05 to 10 μm.

### Electrophotographic Image Forming Apparatus

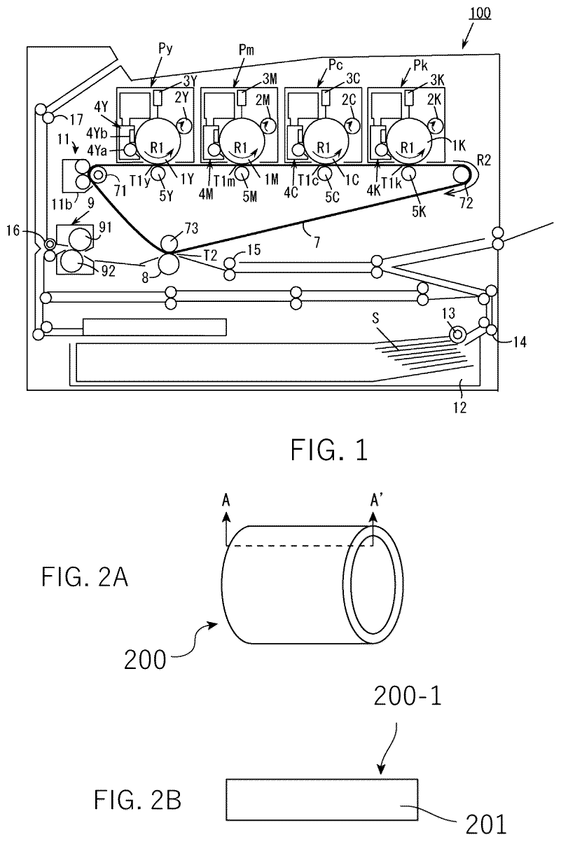

An embodiment of the image forming apparatus including the electrophotographic belt according to the present disclosure as an intermediate transfer belt will be described below. FIG. 1 is a schematic cross-sectional view showing an image forming apparatus 100 of the present embodiment. The image forming apparatus 100 of the present embodiment is a tandem-type color laser printer that employs an intermediate transfer system, which can form a full-color image by using an electrophotographic system.

The image forming apparatus 100 includes, as a plurality of image forming units, first, second, third, and fourth image forming units Py, Pm, Pc, and Pk. The first, second, third, and fourth image forming units Py, Pm, Pc and Pk are arranged in this order along the moving direction of the flat portion (image transfer surface) of an intermediate transfer belt 7, which will be described later. Elements having the same or corresponding functions or configurations in the first, second, third, and fourth image forming units Py, Pm, Pc, and Pk may be collectively described without Y, M, C, and K, each indicating an element color at the end of the reference character. In the present embodiment, the image forming unit P includes a photosensitive drum 1, a charging roller 2, an exposure device 3, a developing device 4, and a primary transfer roller 5.

The image forming unit P includes the photosensitive drum 1 that is a drum-type (cylindrical) photosensitive member (electrophotographic photosensitive member) as an image bearing member. The photosensitive drum 1 is formed by, for example, stacking a charge generation layer, a charge transport layer, and a surface protective layer in this order on an aluminum cylinder serving as a substrate. The photosensitive drum 1 is driven to rotate in the direction of an arrow R1 (counterclockwise) in FIG. 1. The surface of the rotating photosensitive drum 1 is uniformly charged to a predetermined potential of a predetermined polarity (negative polarity in the present embodiment) by the charging roller 2 that is a roller-like charging member as charging means. During the charging step, a predetermined charging bias (charging voltage) containing a DC component of the negative polarity is applied to the charging roller 2. The surface of the charged photosensitive drum 1 is subjected to scanning exposure by the exposure device (laser scanner) 3, which serves as exposing means, according to image information, and an electrostatic image (electrostatic latent image) is formed on the photosensitive drum 1.

The electrostatic image formed on the photosensitive drum 1 is developed (visualized) by supplying a toner as a developer by the developing device 4 serving as developing means, and a toner image (developer image) is formed on the photosensitive drum 1. In the developing step, a predetermined developing bias (developing voltage) containing a DC component of the negative polarity is applied to a developing roller 4a serving as a developer carrier provided in the developing device 4. In the present embodiment, the toner charged with the same polarity as the charge polarity of the photosensitive drum 1 (negative polarity in the present embodiment) adheres to an exposure portion (image portion), which is uniformly charged and then is exposed to reduce the absolute value of potential, on the photosensitive drum 1.

The intermediate transfer belt 7 composed of an endless belt as an intermediate transfer member is opposed to the four photosensitive drums 1. The intermediate transfer belt 7 is extended with a predetermined tension over a drive roller 71, a tension roller 72, and a secondary transfer counter roller 73 that serve as a plurality of extension rollers. By rotating the drive roller 71, the intermediate transfer belt 7 is brought into contact with the photosensitive drum 1 and is rotated (moved circumferentially) in the direction of an arrow R2 (clockwise) in FIG. 1. On the inner peripheral surface of the intermediate transfer belt 7, the primary transfer roller 5, which is a roller-like primary transfer member as primary transfer means, is disposed for each of the photosensitive drums 1.

The primary transfer roller 5 is pressed to the photosensitive drum 1 with the intermediate transfer belt 7 interposed therebetween and forms a primary transfer portion (primary transfer nip) T1 where the photosensitive drum 1 and the intermediate transfer belt 7 are in contact with each other. The toner image formed thus on the photosensitive drum 1 is primarily transferred onto the rotating intermediate transfer belt 7 by the action of the primary transfer roller 5 in the primary transfer portion T1.

During the primary transfer step, a primary transfer bias (primary transfer voltage), which is a DC voltage having a polarity (positive polarity in the present embodiment) opposite to the normal charge polarity (charge polarity during the developing step) of the toner, is applied to the primary transfer roller 5. The primary transfer roller 5 is composed of a metal rotating shaft and an elastic layer formed on the outer peripheral surface of the rotating shaft and is adjusted to a desired resistance value. Such a primary transfer roller is frequently used. However, in recent years, with the trend towards smaller apparatuses and lower cost, there has been an increase in the number of apparatuses that are made of SUM (sulfur and sulfur composite free-cutting steel) or SUS (stainless steel) and are composed of metal rollers extending like straight lines in the thrust direction.

In such a primary transfer, a transfer voltage of several kV is usually applied to obtain a sufficient transfer rate, but at this time, discharge may occur in the vicinity of the transfer nip. The discharge contributes to degradation in the surface characteristics of the intermediate transfer member. When the primary transfer roller is composed of a metal roller, the transfer nip becomes narrower as compared with that of a primary transfer roller having an elastic layer, so that discharge is likely to occur. Accordingly, the effect of the electrophotographic belt according to the present disclosure is more apparently exhibited in the apparatus including the primary transfer roller 5 composed of a metal roller.

On the outer peripheral surface of the intermediate transfer belt 7, a secondary transfer roller 8, which is a roller-like secondary transfer member as secondary transfer means, is disposed at a position facing the secondary transfer counter roller 73. The secondary transfer roller 8 is pressed to the secondary transfer counter roller 73 with the intermediate transfer belt 7 interposed therebetween and forms a secondary transfer portion (secondary transfer nip) T2 where the intermediate transfer belt 7 and the secondary transfer roller 8 are in contact with each other. The toner image formed thus on the intermediate transfer belt 7 is secondarily transferred onto a recording material (sheet or transfer material) S, for example, paper (sheet) held and transported between the intermediate transfer belt 7 and the secondary transfer roller 8 by the action of the secondary transfer roller 8 in the secondary transfer portion T2.

During the secondary transfer step, a secondary transfer bias (secondary transfer voltage), which is a DC voltage having a polarity opposite to the normal charge polarity of the toner, is applied to the secondary transfer roller 8. In the secondary transfer, a transfer voltage of several kV is usually applied to obtain sufficient transfer efficiency. Similarly, the above-mentioned image forming operations are performed in the units Pm, Pc, and Pk of magenta (M), cyan (C), and black (K) according to the movement of the intermediate transfer belt 7, so that toner images of four colors: yellow, magenta, cyan, and black are superimposed on the intermediate transfer belt 7.

The toner layers of the four colors are conveyed according to the movement of the intermediate transfer belt 7 and are collectively transferred onto a recording material S (hereinafter also referred to as “second image bearing member”) transported at a predetermined timing by the secondary transfer roller 8 as secondary transfer means in the secondary transfer portion T2. In such a secondary transfer, a transfer voltage of several kV is usually applied to obtain a sufficient transfer rate, but at this time, discharge may occur in the vicinity of the transfer nip. The discharge contributes to a decrease in the electric resistance value of the intermediate transfer belt.

The recording material S is supplied from a cassette 12, in which the recording material S is stored, to the transport path by a pickup roller 13. The recording material S supplied to the transport path is transported to the secondary transfer portion T2 concurrently with the toner image on the intermediate transfer belt 7 by a transport roller pair 14 and a resist roller pair 15.

The recording material S carrying the transferred toner image is transported to a fixing device 9 serving as fixing means. In the fixing device 9, the recording material S carrying the unfixed toner image is heated and pressed by fixing members 91 and 92, so that the toner image is fixed (melted and fused) onto the recording material S. The recording material S carrying the fixed toner image is ejected (output) to the outside of the main body of the image forming apparatus 100 by a transport roller pair 16 and an ejection roller pair 17 or the like.

In the primary transfer step, the toner (primary untransferred toner) remaining on the surface of the photosensitive drum 1 without being transferred onto the intermediate transfer belt 7 is collected by the developing device 4, which also serves as photosensitive member cleaning means, concurrently with the development. Furthermore, the toner (secondary untransferred toner) remaining on the surface of the intermediate transfer belt 7 without being transferred onto the recording material S in the secondary transfer step is removed and collected from the surface of the intermediate transfer belt 7 by a belt cleaning device 11 serving as intermediate transfer belt cleaning means. The belt cleaning device 11 is disposed downstream of the secondary transfer portion T2 and upstream of a primary transfer unit T1y (a position facing the drive roller 71 in the present embodiment) in the rotation direction of the intermediate transfer belt 7. The belt cleaning device 11 scrapes the secondary untransferred toner from the surface of the rotating intermediate transfer belt 7 with a cleaning blade serving as a cleaning member arranged in contact with the surface of the intermediate transfer belt 7, and stores the toner in a collection container 11b.

In this way, in the image forming operation, the electrical transfer process of the toner image from the photosensitive drum 1 to the intermediate transfer belt 7 and from the intermediate transfer belt 7 to the recording material S is repeatedly performed. In addition, by repeating image formation on multiple recording materials S, the electrical transfer process is further repeated.

The electrophotographic belt is used as the intermediate transfer belt in the electrophotographic image forming apparatus, thereby repeatedly forming an electrophotographic image of high quality over an extended period.

Examples of the electrophotographic belt according to the present embodiment will be described below. Although the steps for the electrophotographic belt according to the present embodiment are all performed using a common apparatus, the present embodiment is not limited to the following examples.

### EXAMPLES

The present disclosure will be specifically described below using examples. In the examples and comparative examples, the number of parts is defined on a mass basis unless otherwise specified.

Commercially available carbon black shown in Table 2 below was prepared as a conductive filler used for the production of the intermediate transfer belt according to the examples and the comparative examples, and the carbon black was subjected to the above-mentioned surface treatment or nitrogen treatment.

The nitrogen treatment was performed as follows: the carbon black to be treated was fired (heat treated) at a temperature of 430° C. for six hours under a nitrogen atmosphere.

The surface treatment was performed as follows:

To 100 parts by mass of water, 10 parts by mass of a nonionic surfactant (polyoxyethylene alkyl ether) (trade name: “NAROACTY”, manufactured by Sanyo Chemical Industries, Ltd.) were added and dissolved, and then 15 parts by mass of raw carbon black (trade name: “#3230B”, manufactured by Mitsubishi Chemical Corporation) were added. At this time, the ratio “A/B” was 1.5, where A represents parts by mass of the raw carbon black and B represents parts by mass of the surfactant with respect to 100 parts by mass of water.

Stirring was performed with a bead mill (trade name: “Alphamill”, manufactured by AIMEX Co., Ltd.) to obtain a raw carbon black dispersion. Moisture was removed from the raw carbon black dispersion using a spray drier (trade name: “Spray drier L-8i”, manufactured by Yamato Scientific Co., Ltd.) to obtain a solid content. The resulting solid content was fired in a high-temperature oven (trade name: “Constant-temperature drier DR200”, manufactured by Yamato Scientific Co., Ltd.) at a temperature of 400° C. for five hours.

The physical properties of the treated carbon black (DBP absorption, the number-average particle diameter of a primary particle, a BET specific surface area, a CB moisture content, and a CB moisture absorption) are shown in Table 2.

DBP absorption: DBP (dibutylphthalate) is dropped to 100 g of carbon black under stirring, and the absorption can be determined from the amount of addition of dibutylphthalate when the torque is maximized (Japan Industrial Standard (JIS) K6217-4:2017). The measuring device was an absorption measurement device (S-500, Asahisouken corporation).

Primary particle diameter: carbon black is typically present in a three-dimensional array of primary particles like a bunch of grapes. The number-average particle diameter of the primary particle (hereinafter also referred to as the primary particle diameter) means the number-average particle diameter of the carbon black (primary particle) of the minimum unit forming one pigment particle.

The primary particle diameter of the carbon black was determined by cross-sectional observation of the base layer. The measurements were conducted with a transmission electron microscope (TEM). Although a thinned sample may be prepared using an ion beam or a diamond knife before observation, an observation cut piece sample having a thickness of 40 nm was collected using “ULTRACUT-S” (trade name, manufactured by Leica Camera AG) in the present disclosure, the piece sample indicating a cross section in the full thickness direction of the base layer.

TEM images were acquired using a transmission electron microscope (TEM) (trade name: H-7100FA, manufactured by Hitachi, Ltd.) on the measurement conditions of the TE mode and an acceleration voltage of 100 kV. Known image analysis software such as “WinROOF” (trade name, manufactured by MITANI CORPORATION) or “ImagePro” (trade name, manufactured by Nippon Roper Co., Ltd.) can be used for analyzing the obtained TEM images. “WinROOF” was used in the present disclosure. Thereafter, the area equivalent diameters of 50 primary particles of carbon black were measured, and the average value was used as the number-average particle diameter of the primary particle.

The BET specific surface area: the BET specific surface area can be determined from the amount of nitrogen adsorbed on the particle surface of the carbon black when the degassed carbon black is immersed in liquid nitrogen and is brought into equilibrium (Japan Industrial Standard (JIS) K6217-2:2017). Specifically, the measuring device was a fully automatic specific-surface-area measuring device (Macsorb by MOUNTECH Co., Ltd.). The measurement condition was 150° C.×3 minutes under the pre-degassing conditions.

TABLE 2

| | | | | | | BET | | CB |
|---|---|---|---|---|---|---|---|---|
| | | | | Primary | | specific | CB | moisture |
| | | | Treatment | particle | DBP | surface | moisture | absorption |
| | | | type of | diameter | absorption | area | content | rate |
| Code | Manufacturer | Trade name | carbon black | mL/100 g | mL/100 g | m²/g | Mass % | Mass % |
| CB-A | Mitsubishi | #3230B | Surface | 23 | 142 | 250 | 2.58 | 1.17 |
| | Chemical | | treatment | | | | | |
| CB-B | Mitsubishi | #3230B | Nitrification | 23 | 140 | 220 | 2.36 | 0.98 |
| | Chemical | | | | | | | |
| CB-C | Mitsubishi | #44B | Surface | 24 | 77 | 130 | 1.04 | 1.13 |
| | Chemical | | treatment | | | | | |
| CB-D | Orion | PrintexL | Surface | 23 | 120 | 155 | 1.49 | 0.42 |
| | Engineered | | treatment | | | | | |
| | Carbons | | | | | | | |
| CB-E | Denka | Denka Black | Surface | 35 | 180 | 70 | 0.23 | 0.21 |
| | | | treatment | | | | | |

### Example 1

### Preparation of Electrophotographic Belt

### Pre-Mixing

PEEK (trade name: 381G, manufactured by Victrex plc.) and the treated carbon black shown in Table 2 were weighed to the compounding ratio shown in Table 3 and were mixed using a Henschel mixer (NIPPON COKE & ENGINEERING CO., LTD., FM-150L/I). The operating conditions and processing conditions of the Henschel mixer are: the number of blade rotations of 1500 rpm, a throughput of 30 kg, a processing time of 5 minutes, and a treatment temperature of 50° C.

### Melting and Kneading

The mixture obtained by the pre-mixing was charged into a two-screw kneader (Ikegai Co., Ltd., PCM43) and was melted and kneaded to obtain a resin composition on conditions that the extrusion amount was 6 kg/h, the number of screw rotations was 100 rpm, and the barrel control temperature was 360° C. During the mixing, reduced-pressure degassing was performed through a vent hole on the upstream side to remove the vapor.

### Melt Extrusion

The resin composition obtained through the melting-kneading step was pelletized. The pellets were then extruded using a single-screw extrusion molding machine (Research Laboratory of Plastics Technology Co., Ltd.) equipped with a spiral cylindrical die at the distal end on conditions that the extrusion amount was 6 kg/h and the die temperature was 380° C., so that an electrophotographic belt was obtained in an endless shape including a base layer of a cylindrical film having a thickness of 60 μm.

### Evaluation of Electrophotographic Belt

The prepared electrophotographic belt was placed for 48 hours in an environment at a temperature of 23° C. and a relative humidity of 50%, and then various evaluations were conducted.

### Evaluation 1: Measurement of Temperature-Lowering Crystallization Temperature

In the differential scanning calorimetry (DSC), the peak temperature detected in the process of lowering the temperature from a molten state is set as the temperature-lowering crystallization temperature. The temperature-lowering crystallization temperature is a peak temperature appearing when the sample is cut out from the base layer to be set in the DSC, is raised in temperature to 400° C. by 10° C./min, and then is reduced in temperature to room temperature (25° C.) by 10° C./min.

The measuring device was a differential scanning calorimeter (DSC Q2000, TA Instruments). Samples were cut out at three points from the central portion of the base layer in a direction perpendicular to the circumferential direction of the electrophotographic belt, and the arithmetic mean of the measured values was employed.

### Evaluation 2: Calculation of Moisture Content of Base Layer

Samples were cut out from the base layer of the manufactured electrophotographic belt, and the water content of the base layer was measured. In the present example, a thermogravimetric measuring device (Q500 manufactured by TA Instruments) was used.

Samples of 4 mm×4 mm cut out from the base layer of the electrophotographic belt were loaded in a platinum sample pan with a capacity of 100 μL such that the total mass reaches 15 mg±4 mg.

In addition, X1 is the mass of the sample when the sample rose in temperature from 30° C. to 100° C. with a rate of 20° C. per minute under a nitrogen atmosphere and was kept at 100° C. for 30 minutes. X2 is the mass of the sample when the sample was then cooled from 100° C. to 30° C. with a rate of 20° C. per minute and was kept in an environment at a temperature of 23° C. and a relative humidity of 50% for 48 hours in the atmosphere.

Moreover, the moisture content of the base layer=((X2−X1)/X2)×100 was used to calculate the moisture content of the base layer. Consequently, the moisture content of the base layer according to the present example was 0.72 mass %.

### Evaluation 3: Mechanical Strength, Flex Resistance

A part of the electrophotographic belt was cut out and a test of flex resistance as mechanical strength was conducted. In the present disclosure, a MIT test under Japanese Industrial Standard (JIS) P8115:2001 was applied as a folding endurance test (flex fatigue test), a bending radius R was changed to 2.5 mm, and the number of times before the occurrence of rupture was evaluated as bending strength as follows:
Rank “A”: Not ruptured even after 1,000,000 times or more
Rank “B”: Ruptured after 100,000 times or more and less than 1,000,000 times
Rank “C”: Ruptured after 10,000 times or more and less than 100,000 times
Rank “D”: Ruptured after less than 10,000 times

The electrophotographic belt evaluated in the present example did not rupture even after 1,000,000 times or more, and the mechanical strength was rank “A”.

### Evaluation 4: Measurement of Surface Resistivity

The electric resistance value of the electrophotographic belt was measured. The electric resistance was measured using Hiresta manufactured by Mitsubishi Chemical Corporation. The surface resistivity was measured at 40 points in total: five points in the width direction and eight points in the circumferential direction with an applied voltage of 100 V after ten seconds. The surface resistivity of the resulting electrophotographic belt was 3.00×10¹⁰Ω/□.

### Evaluation 5: Image Evaluation

The manufactured electrophotographic belt was attached as an intermediate transfer belt to an intermediate transfer unit of a copying machine (Canon Inc., trade name: “IR-ADVANCE C5051”), and then an image quality test was conducted. In a printing test, 600,000 full-color images were printed using A4-size paper (Canon Inc., trade name: “GF-600” (basis weight: 60 g/m²)) in an environment at a temperature of 15° C. and a relative humidity of 10% and a paper feeding durability test was conducted. After the paper feeding durability test, 20 sheets of solid images of magenta were output to confirm the printed image on the entire peripheral surface of the intermediate transfer belt. In the output 20 images, whether image density non-uniformity has occurred as poor image quality was visually confirmed and evaluated on the following criteria:
Rank “A”: No image defect is recognized in all printed images.
Rank “B”: Image defects are recognized in one to three printed images.
Rank “C”: Image defects are recognized in four or more printed images.

No image defect was recognized in the printed images after the paper feeding durability test in the present example. For this reason, the image quality was evaluated as “A”.

### Resistance Drop

After 600,000 sheets were printed, the surface resistivity of the electrophotographic belt was measured on the same conditions as those before the paper feeding durability test. A change in resistance before and after the durability test was calculated from the initial resistance value (the electric resistance value before the paper feeding durability test) and the electric resistance value after the paper feeding durability test. Note that Δ power was obtained by the calculation below. Here, ρ0 is the initial resistance value and ρ is a resistance value after the durability test.

$$Δpower = Log ( ρ0 ) - Log ( ρ ) \qquad ( 3 )$$

The surface resistivity of the electrophotographic belt in example 1 after the paper feeding durability test was 2.74×10¹⁰Ω/□, and the change in resistivity before and after the durability test was 0.03 difference in power.

### Examples 2 and 3, Comparative Examples 1 to 4

Using the material composition and compounding ratios shown in Table 3 below, the electrophotographic belts of Examples 2 and 3 and comparative examples 1 to 4 were prepared in the same process as in example 1. The resulting electrophotographic belts were evaluated in the same manner as in example 1.

### Example 2

The electrophotographic belt was prepared as in example 1 except that the compounding ratio of PEEK to carbon black (CB) was adjusted as shown in Table 3.

### Example 3

The electrophotographic belt was prepared as in example 1 except that the compounding ratio of PEEK to carbon black (CB) was adjusted as shown in Table 3.

### Comparative Example 1

The electrophotographic belt was prepared in the same manner as in example 1 except that the carbon black type was selected and the compounding ratio was adjusted as shown in Table 3.

### Comparative Example 2

The electrophotographic belt was prepared in the same manner as in example 1 except that the carbon black type was selected and the compounding ratio was adjusted as shown in Table 3.

### Comparative Example 3

The electrophotographic belt was prepared in the same manner as in example 1 except that the carbon black type was selected and the compounding ratio was adjusted as shown in Table 3.

### Comparative Example 4

The electrophotographic belt was prepared in the same manner as in example 1 except that the carbon black type was selected and the compounding ratio was adjusted as shown in Table 3.

The evaluation results of the electrophotographic belts prepared in examples 1 and 2 and comparative Examples 1 to 4 are shown in Table 3.

In example 1, the image was highly evaluated after the paper feeding durability test.

It is believed that a change in resistance value was small before and after the paper feeding durability test and a resistance value is less likely to change even when discharge occurs in a gap between the inner peripheral surface of the intermediate transfer member in the primary transfer unit and the primary transfer roller or between the outer peripheral surface of the intermediate transfer member in the secondary transfer unit and a sheet. Consequently, it is believed that image defects did not occur even after the paper feeding durability test.

Moreover, in example 2, even when the amount of carbon black increases, no degradation in cracking resistance was observed.

In example 3, even when the amount of carbon black was small, no resistance drop was observed due to the moisture content of the belt.

In the electrophotographic belt according to comparative example 1, degradation in cracking resistance was confirmed because the temperature-lowering crystallization temperature was high. It is believed that the carbon black used in comparative example 1 had a small BET specific surface area because only a few fine protruded portions are formed on the surface, resulting in the high temperature-lowering crystallization temperature.

Also in the electrophotographic belt according to comparative example 2, degradation in cracking resistance was confirmed because the temperature-lowering crystallization temperature was high.

Also in the electrophotographic belt according to comparative example 3, degradation in cracking resistance was confirmed because the temperature-lowering crystallization temperature was high. In comparative example 3, since the moisture content of the base layer was small, the conductivity changed over time and an image defect occurred.

In the electrophotographic belt according to comparative example 4, since the moisture content of the base layer was small, the conductivity largely changed over time and an image defect occurred. The electrophotographic belt according to comparative example 4 had high mechanical strength, though the temperature-lowering crystallization temperature of the base layer was high. This is because the content of carbon black was low in the base layer. Furthermore, the reason why the temperature-lowering crystallization temperature of the base layer was high in the electrophotographic belt according to comparative example 4 is that acetylene black that is likely to become a crystal nucleus of PEEK was used as carbon black.

TABLE 3

| | | | | | | | | | Image evaluation | | | |
|---|---|---|---|---|---|---|---|---|---|---|---|---|
| | | | | | Temperature- | | | | result after | | | |
| | | | | | lowering | Surface | Moisture | Change | durability test | | Mechanical strength | |
| | | PEEK | | CB | crystallization | resistivity | content of | in surface | | Number of | MIT | |
| | | ratio | CB | amount | temperature | ×10¹⁰ | base layer | resistivity | | image | strength | Number of |
| | | Mass % | type | Mass % | ° C. | Ω/□ | Mass % | Δ power | Rank | defects | rank | bends |
| Example | 1 | 80 | CB-A | 20 | 287.7 | 3.0 | 0.72 | 0.03 | A | 0 | A | 1000,000 |
| | | | | | | | | | | | | or more |
| | 2 | 76 | CB-A | 24 | 286.6 | 1.4 | 0.81 | 0.04 | A | 0 | A | 1000,000 |
| | | | | | | | | | | | | or more |
| | 3 | 82 | CB-A | 18 | 287.7 | 5.3 | 0.50 | 0.03 | A | 0 | A | 1000,000 |
| | | | | | | | | | | | | or more |
| Comparative | 1 | 76 | CB-B | 24 | 289.2 | 1.7 | 0.73 | 0.03 | A | 0 | B | 700,000 |
| example | 2 | 76 | CB-C | 24 | 289.5 | 2.1 | 0.55 | 0.12 | A | 0 | B | 650,000 |
| | 3 | 80 | CB-D | 20 | 290.4 | 5.0 | 0.25 | 0.80 | B | 3 | B | 540,000 |
| | 4 | 83 | CB-E | 17 | 300.7 | 4.0 | 0.19 | 4.00 | C | 12 | A | 1000,000 |
| | | | | | | | | | | | | or more |

The number of bends indicates the number of bends when the electrophotographic belt ruptures. “1,000,000 times or more” indicates that no rupture occurred even after 1,000,000 bends are made.

As described above, a resistance drop can be suppressed by increasing the moisture content of the base layer of the electrophotographic belt, and the cracking resistance can be improved by lowering the temperature-lowering crystallization temperature. This can achieve the electrophotographic belt that can suppress a reduction in electric resistance value and obtain cracking resistance even after long-term use.

According to at least one aspect of the present disclosure, an electrophotographic belt can be obtained, which can achieve, at a higher level, suppression of a change (increase) in the conductivity of the electrophotographic belt over a long period of time and prevention of cracking during long-term use. In addition, at least one aspect of the present disclosure can obtain an electrophotographic image forming apparatus that can stably form an electrophotographic image of high quality for a long period of time.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An electrophotographic belt comprising at least a base layer, wherein
the base layer comprises polyether ether ketone, which is a thermoplastic resin, and carbon black,
a content of the carbon black is 18 to 30 mass % with respect to a mass of the base layer, and
the base layer has a moisture content of at least 0.50 mass %, which is calculated by
$$the moisture content of the base layer = ( ( X 2 - X 1 ) / X 2 ) \times 100 ,$$
where X1 is a mass of a sample when the sample cut from the base layer rises in temperature from 30° C. to 100° C. with a rate of 20° C. per minute under a nitrogen atmosphere and is kept at 100° C. for 30 minutes, and X2 is a mass of the sample when the sample is cooled from 100° C. to 30° C. with a rate of 20° C. per minute and is kept in an environment at a temperature of 23° C. and a relative humidity of 50% for 48 hours in an atmosphere, and
a temperature-lowering crystallization temperature of the base layer is not higher than 288.0° C. that is measured in differential scanning calorimetry.

2. The electrophotographic belt according to claim 1, wherein the content of the carbon black is 19 to 30 mass % with respect to the mass of the base layer.

3. The electrophotographic belt according to claim 1, wherein a number-average particle diameter of primary particles of the carbon black is at least 15 nm and smaller than 35 nm.

4. The electrophotographic belt according to claim 1, wherein the carbon black has a moisture absorption rate of at least 0.70 mass % as determined by following formula (1):
$$Moisture absorption rate = [ ( W 0 - W 1 ) / W 0 ] \times 100 \qquad ( 1 )$$
where W0 is a mass of the carbon black when the mass is measured using a thermogravimetric analyzer after the carbon black is placed for 48 hours on conditions under which a temperature is 23° C. and a relative humidity is 50%, and W1 is a mass of the carbon black when the carbon black measuring W0 is raised in temperature from 30° C. to 120° C. with a rate of 20° C. per minute under a nitrogen atmosphere, and is kept at 120° C. for 15 minutes, the mass being similarly measured using the thermogravimetric analyzer.

5. The electrophotographic belt according to claim 1, wherein the carbon black has a BET specific surface area of at least 240 m²/g.

6. The electrophotographic belt according to claim 1, wherein the carbon black comprises furnace black.

7. The electrophotographic belt according to claim 1, wherein the carbon black has on a surface thereof a protruded portion of an organic compound.

8. The electrophotographic belt according to claim 1, wherein the moisture content of the base layer is 0.70 to 1.00 mass %.

9. The electrophotographic belt according to claim 1, wherein the base layer has a surface resistivity of from 1.0×10³Ω/□ to 1.0×10¹⁴Ω/□.

10. The electrophotographic belt according to claim 1, wherein the base layer has a thickness of 25 to 100 μm.

11. The electrophotographic belt according to claim 1, wherein the electrophotographic belt is an intermediate transfer belt.

12. An electrophotographic image forming apparatus comprising an electrophotographic belt comprising at least a base layer, wherein
the base layer comprises polyether ether ketone, which is a thermoplastic resin, and carbon black,
a content of the carbon black is 18 to 30 mass % with respect to a mass of the base layer, and
the base layer has a moisture content of at least 0.50 mass %, which is calculated by
the moisture content of the base layer=((X2−X1)/X2)×100,
where X1 is a mass of a sample when the sample cut from the base layer rises in temperature from 30° C. to 100° C. with a rate of 20° C. per minute under a nitrogen atmosphere and is kept at 100° C. for 30 minutes, and X2 is a mass of the sample when the sample is cooled from 100° C. to 30° C. with a rate of 20° C. per minute and is kept in an environment at a temperature of 23° C. and a relative humidity of 50% for 48 hours in an atmosphere, and
a temperature-lowering crystallization temperature of the base layer is not higher than 288.0° C. that is measured in differential scanning calorimetry.

13. The electrophotographic image forming apparatus according to claim 12, wherein the electrophotographic belt is provided as an intermediate transfer belt.
